(19) United States
(12) Patent Application Publication
(10) Pub. No.: US 2021/0150924 A1
(43) Pub. Date: May 20, 2021

(54) Interactive situational teaching system for use in K12 stage

(71) Applicant: SHENZHEN EAGLESOUL TECHNOLOGY CO., LTD., Shenzhen (CN)

(72) Inventors: Ning YANG, Dalian (CN); Meijie LU, Shenzhen (CN); Xin LU, Chengdu (CN)

(21) Appl. No.: 16/630,819

(22) PCT Filed: Oct. 10, 2017
(86) PCT No.: PCT/CN2017/105549

§ 371 Date: Jan. 13, 2020

(30) Foreign Application Priority Data
Jul. 25, 2017 (CN) 201710609500.9

(51) Int. Cl. G09B 5/06; G10L 15/26; G06F 16/903; G09B 5/14; G09B 5/12

(52) U.S. Cl. CPC G09B 5/067; G10L 15/26; G09B 5/125; G09B 5/14; G06F 16/90344

(57) ABSTRACT

Provided is an interactive situational teaching system for use in K12 stage, comprising a computer apparatus and a scenario creating apparatus, an image acquiring apparatus and a user terminal connected to the computer apparatus, wherein the computer apparatus is configured to receive an operation instruction from the user terminal to control the scenario creating apparatus and the image acquiring apparatus, and the computer apparatus is capable of synthesizing and saving situational audio/video information obtained from the image acquiring apparatus and user audio/video information obtained from the user terminal as an audio/video file, and is also capable of presenting the audio/video file via the scenario creating apparatus. By using the system of the present invention, the experience and interest of a K12 stage user participating in interactive situational teaching is further enhanced, which is also applicable in solving the problem of coursework submission for interactive situational teaching.

### CROSS-REFERENCE TO RELATED APPLICATIONS

This application is a national stage application of PCT Application No. PCT/CN2017/105549. This Application claims priority from PCT Application No. PCT/CN2017/105549 filed Oct. 10, 2017, CN Application No. CN 2017106095009 filed Jul. 25, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present invention belongs to the technical field of educations, and relates to an interactive situational teaching system for use in K12 stage.

### BACKGROUND ART

As a basic education, the education of K12 (generally the basic education from kindergarten to senior three) stage has received more and more attention. For the characteristics of students in this stage, interactive situational teaching is a very important aspect. Especially in the field of Internet education technology, there are already patent applications that focus on the technology of interactive situational teaching, for example:

CN204965778U discloses an early childhood teaching system based on virtual reality and visual positioning, wherein a teacher, mainly by means of a master control computer, a projector, a camera and a touch device, can conveniently present a projection image in an orientation within a teaching area, so that a virtual reality teaching environment of a full-space virtual scenario is formed and enables children to experience and interact in the virtual environment, children's touch signals are acquired by the interactive touch device, children's position information are determined by the camera, children's action characteristics are identified, and children's interactive operations are fed back, thereby achieving immersive interactive teaching activities.

CN106557996A discloses a second language teaching system, wherein the system achieves simulation of real scenarios and personalized services by means of a computing apparatus that performs electronic communication through a network and a server, a language ability testing unit that tests a second language ability of a user, a learning outline customization unit that receives user learning demand information, a life simulation part in which the user interacts with a virtual character in one or more life simulation interaction tasks of a virtual world, and a virtual place management unit that downloads the one or more life simulation interaction tasks from the server to a computer.

US2014220543A1 discloses an on-line education system with multiple navigation modes, wherein the system may be provided with a plurality of apparatuses providing activities, each activity is related to a skill, interest or expertise area, a user can select one of multiple sequential activities according to the apparatus of a sequential navigation mode, select one or more activities in the one or more skill, interest or expertise areas from a parent group of activities according to the apparatus of an instructive navigation mode to create a subgroup, and select an activity from the parent group of activities by using the apparatus of an independent navigation mode, so that the interaction between a computer and the user is improved, and everyone is allowed to have the opportunity to discover, explore, and browse the content of learning effectively.

CN103282935A discloses a computer-implemented system comprising a means for enabling a digital processing device to provide several activities, each activity being related to a skill, interest or expertise area; a means for enabling the digital processing device to provide a sequential navigation mode, wherein the system presents a user with a preset sequence of more than one activity in one or more skill, interest or expertise areas, and the user must complete each preceding activity in the sequence to proceed to the next one; a means for enabling the digital processing device to provide an instructive navigation mode, wherein the system presents the user with one or more activities in the one or more skill, interest or expertise areas selected by an instructor from an parent group of activities to create a subgroup of activities; and a means for enabling the digital processing device to provide an independent navigation mode, wherein the user selects an activity from the parent group of activities, and the system in this application is capable of creating a virtual environment for interaction with the user, and interacts with the user by using the technical features of the computer system.

CN105573592A discloses an intelligent interaction system for preschool education, including a remote controller, a projection lens and a master control unit; underlying development programs for all functional application units are integrated by a main framework program, the functional application units including an interactive story unit using AR technology and an interactive learning unit developed by using Unity technology.

CN106569469A discloses a remote monitoring system for a home farm, including a user terminal and an on-site terminal, the user terminal including a processing unit and a video unit, an upper communication unit and a control unit connected to the processing unit.

CN106527684A discloses a method of moving based on an augmented reality technology, applied to an intelligent terminal including a camera and a projector, the method including: acquiring a target feature image via the camera; acquiring a virtual three-dimensional material corresponding to the target feature image, and projecting and displaying the virtual three-dimensional material via the projector; acquiring an image of the user moving in the projected virtual three-dimensional material via the camera; and projecting and displaying the acquired image via the projector to pull a user moving in reality into a virtual three-dimensional environment corresponding to the virtual three-dimensional material. The virtual three-dimensional material is developed in advance by using a virtual three-dimensional material development tool according to the feature image and stored in the intelligent terminal. The intelligent terminal further comprises a speech acquisition component through which speech information of the user is acquired; the content in the projected virtual three-dimensional material is adjusted according to the acquired speech information, so as to interact with the user during the movement of the user. The virtual three-dimensional material includes: a virtual three-dimensional scenario, a virtual three-dimensional object or a virtual three-dimensional animated video.

CN10106683501A discloses an AR child scenario play projection teaching method comprising: S1, acquiring an AR interactive card image, a user face image, real-time user body movement data and a user speech, wherein the real-time user body movement data is acquired by using a depth sensing device; S2: identifying information of the AR interactive card image, and invoking a 3D scenario play template corresponding to the AR interactive card, the 3D scenario play template including a 3D role model and a background model, the 3D role model consisting of a face model and a body model, the background model being dynamic or static; S3, cutting the user face image, and synthesizing the cut face image into the face model of the 3D role model; S4: performing data interaction between the real-time user body movement data and the body model of the 3D role model to control body movement of the 3D role model; S5, performing tone changing on the user speech; and S6, converting the 3D scenario play template invoked in S2 into a projection and projecting same onto a projection screen, wherein the background model is converted into a dynamic or static background projection, the 3D role model is correspondingly converted into a dynamic 3D role projection according to the real-time user body movement, and the tone changed user speech is played during projection.

By virtue of the above existing technologies, it can be found that there is no technical conception for complete and comprehensive interaction of situational teaching in the prior art, which is difficult for any teaching test or experiment, and requires special processing. Many interactive situational teachings are more often regarded as practical courses, and there is nothing worth to record after class, and there also exists many difficulties in exam or coursework. In fact, this is because such a situational teaching system lacks a function and link for feeding back by a final user.

Therefore, a heretofore unaddressed need exists in the art to address the aforementioned deficiencies and inadequacies.

### SUMMARY OF THE INVENTION

In view of the above problems, the present invention provides an interactive situational teaching system for use in K12 stage, comprising a computer apparatus and a scenario creating apparatus, an image acquiring apparatus and a user terminal connected to the computer apparatus, wherein
the image acquiring apparatus comprises a camera for remotely acquiring situational audio/video information of situational teaching;
the scenario creating apparatus comprises a projection device and a sound device, and is configured to project a predetermined scenario stored in the computer apparatus or an actual scenario obtained by the image acquiring apparatus to a target area to display a situational teaching scenario;
the user terminal comprises a recording apparatus and a videoing apparatus, and is configured to acquire user audio/video information and send an operation instruction from a user to the computer apparatus; and
the computer apparatus is configured to receive the operation instruction from the user terminal, control the scenario creating apparatus and the image acquiring apparatus, and synthesize and save the situational audio/video information obtained from the image acquiring apparatus and the user audio/video information obtained from the user terminal as an audio/video file.

The computer apparatus comprises a situational audio/video extracting unit, a user audio/video acquiring unit, and an information synthesizing and saving unit, wherein
the situational audio/video extracting unit is configured to extract, according to the preset information set based on a teaching goal, a segment of the situational audio/video information acquired from the image acquiring apparatus that is related to the preset information, such as a video segment, an audio segment or a screenshot image, and establish an association relationship between the preset information and a segment in an order;
the user audio/video acquiring unit is configured to segment, according to the preset information set based on the teaching goal, the user audio/video information acquired by the user terminal, and establish an association relationship between the preset information and a segment; and
the information synthesizing and saving unit is configured to synthesize, according to the preset information, the situational audio/video information and the user audio/video information respectively processed by the situational audio/video extracting unit and the user audio/video acquiring unit into an audio/video file, and save the audio/video file to the computer apparatus.

The situational audio/video extracting unit further comprises an information presetting unit, an information comparing unit, a data extracting unit, and a data saving unit, wherein
the information presetting unit is configured to take key points as preset information according to the teaching goal, particularly outline text information of the teaching goal, and set an audio and/or image corresponding to the preset information as reference information;
the information comparing unit is configured to compare the situational audio/video information with the audio and/or image of the reference information, to acquire a time node of the situational audio/video information corresponding to the preset information;
the data extracting unit is configured to extract situational audio/video information corresponding to the preset information based on the time node according to a preset rule of, for example, extracting an image at a fixed time interval, extracting a video segment or an audio segment at a fixed time interval, etc.; and
the data saving unit is configured to save the extracted situational audio/video information in an order, and establish a corresponding association relationship with the preset information.

The user audio/video acquiring unit further comprises an audio recognizing unit, a text comparing unit, and a segment marking unit, wherein
the audio recognizing unit is configured to recognize and convert an audio in the obtained user audio/video information into a text content according to a speech recognition model, and establish a corresponding association relationship between the text content and the user audio/video information according to time information, such as digital time stamp information;
the text comparing unit is configured to perform search comparison on the text content according to the preset information, and establish a corresponding association relationship for the text content according to the preset information;
the segment marking unit is configured to establish, according to the corresponding association relationships respectively obtained by the audio recognizing unit and the text comparing unit, a corresponding association relationship between the preset information and the user audio/video information based on the text content, and perform segment marking on the user audio/video information according to the key points of the preset information.

The information synthesizing and saving unit further comprises a corresponding relationship processing unit, a data compression processing unit, a time fitting processing unit, and a data synthesis processing unit, wherein
the corresponding relationship processing unit is configured to associate, according to the corresponding association relationship with the preset information, the user audio/video information subjected to the segment marking with the situational audio/video information segment extracted by the situational audio/video extracting unit, and establish a corresponding relationship between the user audio/video information and the situational audio/video information;
the data compression processing unit is configured to perform compression processing on the corresponding situational audio/video information according to a preset rule and based on the duration of a user audio/video information segment to meet the time requirement of the preset rule;
the time fitting processing unit is configured to perform fitting processing on the user audio/video information based on the segment marking according to the compressed situational audio/video information, for example, add an idle time between segments to complete the play of the situational audio/video information; and
the data synthesis processing unit is configured to synthesize, according to the corresponding relationship, the user audio/video information and the situational audio/video information after the fitting processing to form an audio/video file.

The synthesized audio/video file is played by the scenario creating apparatus.

The synthesized audio/video file is submitted to a teacher as a coursework of situational teaching.

The recording apparatus and the videoing apparatus of the user terminal are apparatuses built in or provided external to the user terminal.

The user terminal is a desktop computer, a notebook computer, a smart phone, or a PAD.

The user audio/video information is a recorded summative explanation in the order of the key points of the teaching goal according to the requirements of the teaching goal after the user completes the learning or practice of the situational teaching.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

FIG. 1 is a schematic diagram of a composition architecture of an interactive situational teaching system according to the present invention;

FIG. 2 is a schematic diagram of functional composition of a computer apparatus according to the present invention;

FIG. 3 is a schematic diagram of functional composition of a situational audio/video extracting unit according to the present invention;

FIG. 4 is a schematic diagram of functional composition of a user audio/video acquiring unit according to the present invention; and

FIG. 5 is a schematic diagram of functional composition of an information synthesizing and saving unit according to the present invention.

### DETAILED DESCRIPTION OF EMBODIMENTS

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The specific embodiments of the present invention will be further described in detail below in combination with the accompanying drawings. It should be understood that the embodiments described herein are used only to explain the present invention, rather than limit the present invention. Various variations and modifications made by those skilled in the art without departing from the spirit of the present invention shall fall into the scope of the independent claims and dependent claims of the present invention.

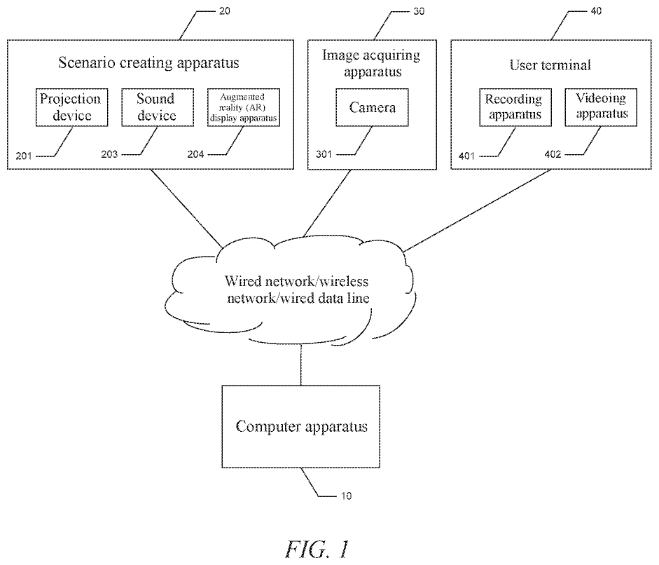

FIG. 1 shows a schematic diagram of a composition architecture of an interactive situational teaching system according to the present invention. An interactive situational teaching system for use in K12 stage according to the present invention comprises: a computer apparatus 10, and a scenario creating apparatus 20, an image acquiring apparatus 30 and a user terminal 40 connected to the computer apparatus 10. The scenario creating apparatus 20, the image acquiring apparatus 30, and the user terminal 40 may be connected to the computer apparatus 10 over a wired network or a wireless network or via wired data lines. The so-called interactive situational teaching refers to a teaching method that users, especially student users of K12 stage can participate in a learning process, and students' learning emotions are stimulated in a vivid scenario. This kind of teaching usually relies on a vivid and realistic scenario. The interactive situational teaching of the present invention preferably relies on a teaching scenario in which vivid and regularly changing audio/video information can be obtained, for example, plant growth observation, animal feeding observation, weather observation, handcrafting, etc. Of course, the present invention does not limit a specific teaching scenario as long as the system of the present invention can be applied thereto according to its function.

The image acquiring apparatus 30 comprises at least one camera 301 for remotely acquiring situational audio/video information of situational teaching. The camera 301 may be provided with a camera of an audio acquiring apparatus, or may have an audio acquiring apparatus that is separately provided. Preferably, the camera 301 is a high definition camera.

The scenario creating apparatus 20 comprises a projection device 201 and a sound device 203, and is configured to project a predetermined scenario stored in the computer apparatus 10 or an actual scenario obtained by the image acquiring apparatus 30 to a target area to display a situational teaching scenario. Preferably, the scenario creating apparatus 20 further comprises an augmented reality (AR) display apparatus 204 for displaying image information to be projected in an AR manner after the image information is processed, so that a user can view it by using a corresponding viewing device.

The user terminal 40 comprises a recording apparatus 401 and a videoing apparatus 402, and is configured to acquire user audio/video information and send an operation instruction from the user to the computer apparatus. The interactive situational teaching system may be provided with a plurality of user terminals 40, or user terminals 40 with which any user can access the system as permitted. For many intelligent user terminals, the recording apparatus 401 and the videoing apparatus 402 have been integrated, but for a higher quality of audio/video data or other reasons, peripheral apparatuses for recording and videoing such as high-fidelity microphones or high-definition cameras may be used. According to the present invention, a user uses the user terminal 40 to perform learning in the interactive situational teaching. When the user completes the learning or practice in the situational teaching, or before the end of the learning, summative explanation is performed in an order of key points of a teaching goal according to the requirements of the teaching goal to form user audio/video information described below. Specifically, the user terminal 40 may be a desktop computer, a notebook computer, a smart phone, or a PAD, but is not limited thereto, any device that satisfies the following functions can be used.

The user terminal 40 may comprise: a processor, a network module, a control module, a display module, and an intelligent operating system. The user terminal may be provided with a variety of data interfaces for connecting to various extension devices and accessory devices via a data bus. The intelligent operating system comprises Windows, Android and its improvements, and iOS, on which application software can be installed and run so as to realize functions of various types of application software, services, and application program stores/platforms under the intelligent operating system.

The user terminal 40 may be connected to the Internet by RJ45/Wi-Fi/Bluetooth/2G/3G/4G/G.hn/Zigbee/Z-ware/RFID, connected to other terminals or other computers and devices via the Internet, and connected to various extension devices and accessory devices by using a variety of data interfaces or bus modes, such as 1394/USB/serial/SATA/SCSI/PCI-E/Thunderbolt/data card interface, and by using a connection mode like an audio/video interface, such as HDMI/YpbPr/SPDIF/AV/DVI/VGA/TRS/SCART/Displayport so as to constitute a conference/teaching device interaction system. The functions of acoustic control and shape control are realized by using a sound capture control module and a motion capture control module in the form of software, or by using a sound capture control module and a motion capture control module in the form of data bus on-board hardware; the display, projection, voice access, audio/video playing, as well as digital or analog audio/video input and output functions are realized by connecting to a display/projection module, a microphone, a sound device and other audio/video devices via audio/video interfaces; the image access, sound access, use control and screen recording of an electronic whiteboard, and an RFID reading function are realized by connecting to a camera, a microphone, the electronic whiteboard and an RFID reading device via data interfaces, and a mobile storage device, a digital device and other devices can be accessed and managed and controlled via corresponding interfaces; the functions including manipulation, interaction and screen shaking between multi-screen devices are realized by means of DLNA/IGRS technologies and Internet technologies.

In the present invention, the processor of the user terminal 40 is defined to include but not limited to: an instruction execution system, such as a computer/processor-based system, an application specific integrated circuit (ASIC), a computing device, or a hardware and/or software system capable of fetching or acquiring logic from a non-transitory storage medium or a non-transitory computer-readable storage medium and executing instructions contained in the non-transitory storage medium or the non-transitory computer-readable storage medium. The processor may further comprise any controller, state machine, microprocessor, Internet-based entity, service or feature, or any other analog, digital, and/or mechanical implementation thereof.

In the present invention, the computer-readable storage medium is defined to include but not limited to: any medium capable of containing, storing or maintaining programs, information and data. The computer-readable storage medium includes any of many physical media, such as an electronic medium, a magnetic medium, an optical medium, an electromagnetic medium or a semiconductor medium. More specific examples of memories suitable for the computer-readable storage medium and the user terminal and server include but not limited to: a magnetic computer disk (such as a floppy disk or a hard drive), a magnetic tape, a random access memory (RAM), a read only memory (ROM), an erasable programmable read only memory (EPROM), a compact disk (CD) or digital video disk (DVD), Blu-ray memory, a solid state disk (SSD), and a flash memory.

The computer apparatus 10 is configured to receive the operation instruction from the user terminal 40, control the scenario creating apparatus 20 and the image acquiring apparatus 30, and synthesize and save the situational audio/video information obtained from the image acquiring apparatus 30 and the user audio/video information obtained from the user terminal 40 as an audio/video file. The computer apparatus 10 may be any commercial or home computer device that meets actual needs, such as an ordinary desktop computer, a notebook computer, or a tablet computer. The above functions of the computer apparatus 10 are performed and implemented by its functional units.

The user terminal 40 of the user is connected to the computer apparatus 10 in a wired or wireless manner through a network or a data cable to receive or actively carry out the learning of a situational teaching subject. For example, the user can perform situational learning on such topics by using the system of the present invention, for example, observe blooming of a flower in the season when it is in bloom, such as in spring, observe changes of red leaves in autumn, observe lightning in a lightning weather, or observe seed germination. As an example, the process of observing the blooming of a flower is taken as a teaching scenario. After the user sends a learning instruction via the user terminal 40, the computer apparatus 10 receives the instruction to acquire a camera 301 for observing the flower. The camera 301 may be a camera specially set up in a wild field or indoor, or may be, for example, a public monitoring camera in a botanical garden or in a forest, and these cameras may be invoked according to a license agreement. Some flowers may take a long time to bloom, while some flowers may take a short time to bloom, such as night-blooming cereus. Specifically, according to the content of a syllabus of a situational teaching, the time when the camera 301 starts monitoring and acquiring situational audio/video information is set. For example, audio/video information may be regularly monitored and acquired from the beginning of buds. For example, a corresponding acquisition time interval of audio/video information is set according to the blooming speed of a flower. The acquired situational audio/video information may be displayed regularly or irregularly by the scenario creating apparatus 20 in order to observe the real time status, as well as situation changes.

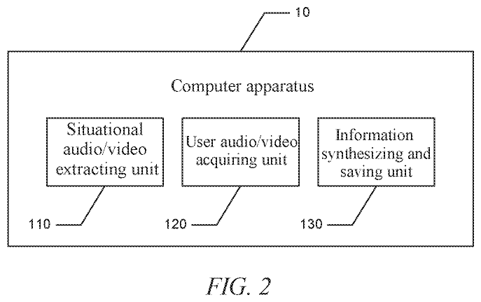

FIG. 2 shows a schematic diagram of functional composition of a computer apparatus according to the present invention. The computer apparatus 10 comprises a situational audio/video extracting unit 110, a user audio/video acquiring unit 120, and an information synthesizing and saving unit 130. The situational audio/video extracting unit 110 is configured to extract, according to preset information set based on a teaching goal, a segment of the situational audio/video information acquired from the image acquiring apparatus 30 that is related to the preset information, such as a video segment, an audio segment or a screenshot image, and establish an association relationship between the preset information and a segment in an order. A large amount of audio/video information may be acquired during the learning process of the situational teaching, but the audio/video information is not all necessary. The audio/video information related to the key points set based on the teaching goal is the most concerned, and such information should be extracted from the large amount of audio/video information. The user audio/video acquiring unit 120 is configured to segment, according to the preset information set based on the teaching goal, the user audio/video information acquired by the user terminal 40, and establish an association relationship between the preset information and a segment. Preferably, after completing the learning of the situational teaching, the user responds to the requirements of the teaching goal one by one according to the requirements of the teaching goal or the outline, thereby forming user audio/video information. The information synthesizing and saving unit 130 is configured to synthesize, according to the preset information, the situational audio/video information and the user audio/video information respectively processed by the situational audio/video extracting unit 110 and the user audio/video acquiring unit 120 into an audio/video file, and save the audio/video file to the computer apparatus 10. By such synthesis, the user's summary or content of coursework made according to the teaching goal is combined and corresponded with the audio/video information acquired during the situational teaching process to form a unified file, so that a student speaks out in his own language through words organized by himself after completing such observation or learning, thereby enabling the student to participate in the situational teaching during the whole course, and have a complete end or learning summary. Accordingly, the problem in the past that the situational teaching process is very exciting, but students remember nothing afterwards and lack of a deep sense of participation is solved.

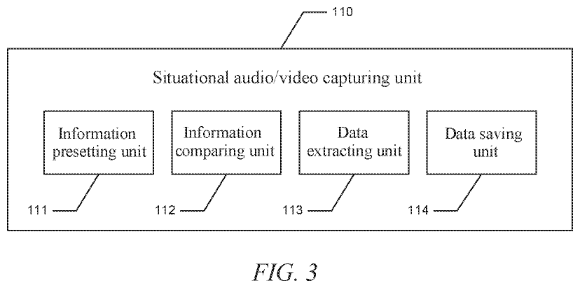

FIG. 3 shows a schematic diagram of functional composition of a situational audio/video extracting unit according to the present invention. The situational audio/video extracting unit 110 further comprises an information presetting unit 111, an information comparing unit 112, a data extracting unit 113, and a data saving unit 114. The information presetting unit 111 is configured to take key points as preset information according to the teaching goal, particularly outline text information of the teaching goal, and set an audio and/or image corresponding to the preset information as reference information. For example, for the observation teaching of flower blooming, the teaching goal includes, for example, observation of a bud period, a flowering period, a full blooming period, a flower falling period, etc., and these key points, that is, keywords can be taken as preset information. For the specific meaning of the preset information that the computer fails to recognize, in order to recognize the meanings of these key points, existing reference audio files or reference images corresponding to the key points, such as existing bud period images and blooming period images of the flower or audios of lightning if observing the lightning, are preferably set in the present invention, these images or audios are used as reference data, and the computer apparatus 10 compares, after acquiring corresponding information, the information with the set reference images to determine, for example, by a determination information comparing unit 12, the stage in which the current observed object is. The determination information comparing unit 12 is configured to compare the situational audio/video information with the audio and/or image of the reference information, to acquire a time node of the situational audio/video information corresponding to the preset information. For example, in the bud period, a photo is shot or a frame of a video is extracted at certain time interval according to the length of the bud period till the blooming period, then a corresponding acquisition time interval is set according to the rule requirements, time parameters and the like, and the image data is continuously played to form dynamic change image information corresponding to the key points of the teaching goal. The data is specifically extracted by the data extracting unit 113, and the extracted data which is unused can be deleted. The data extracting unit 113 is configured to extract situational audio/video information corresponding to the preset information based on the time node according to a preset rule of, for example, extracting an image at a fixed time interval, extracting a video segment or an audio segment at a fixed time interval, etc. The data saving unit 114 is configured to save the extracted situational audio/video information in an order, and establish a corresponding association relationship with the preset information.

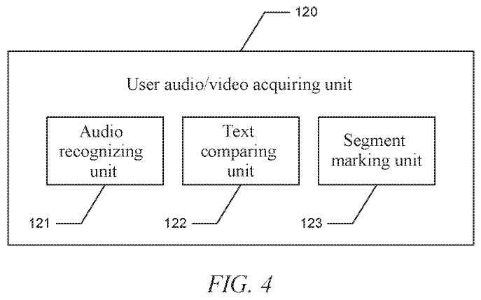

FIG. 4 shows a schematic diagram of functional composition of a user audio/video acquiring unit according to the present invention. The user audio/video acquiring unit 120 further comprises an audio recognizing unit 121, a text comparing unit 122, and a segment marking unit 123. The audio recognizing unit 121 is configured to recognize and convert an audio in the obtained user audio/video information into a text content according to a speech recognition model, and establish a corresponding association relationship between the text content and the user audio/video information according to time information, such as digital time stamp information. The text comparing unit 122 is configured to perform search comparison on the text content according to the preset information, and establish a corresponding association relationship for the text content according to the preset information. The segment marking unit 123 is configured to establish, according to the corresponding association relationships respectively obtained by the audio recognizing unit and the text comparing unit, a corresponding association relationship between the preset information and the user audio/video information based on the text content, and perform segment marking on the user audio/video information according to the key points of the preset information. After or at the end of completing the learning, a user uses the user terminal 40 to describe in text the observation content required according to the teaching goal, or to make a summary in words in a improvise manner. Of course, such behavior may be a requirement of the teaching, and making a summary in an order based on the teaching goal is also a requirement of the teaching. After the user's speech is recognized as a text, the user recognizes and compares the text content with the key points of the teaching goal, so that the user's audio/video information is segmented and associated with the teaching goal.

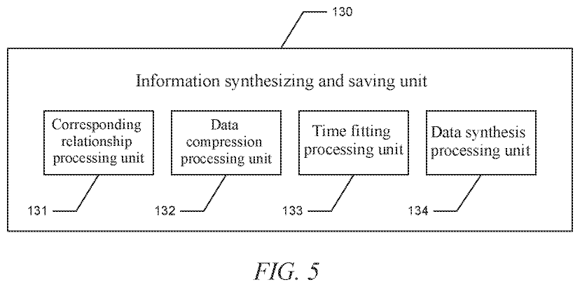

FIG. 5 shows a schematic diagram of functional composition of an information synthesizing and saving unit according to the present invention. The information synthesizing and saving unit 130 further comprises a corresponding relationship processing unit 131, a data compression processing unit 132, a time fitting processing unit 133, and a data synthesis processing unit 134. The corresponding relationship processing unit 131 is configured to associate, according to the corresponding association relationship with the preset information, the user audio/video information subjected to the segment marking with the situational audio/video information segment captured by the situational audio/video extracting unit, and establish a corresponding relationship between the user audio/video information and the situational audio/video information. The data compression processing unit 132 is configured to perform compression processing on the corresponding situational audio/video information according to a preset rule based on the duration of a user audio/video information segment to meet the time requirement of the preset rule. The time fitting processing unit 133 is configured to perform fitting processing on the user audio/video information based on the segment marking according to the compressed situational audio/video information, for example, add an idle time between segments to complete the play of the situational audio/video information. The data synthesizing processing unit 134 is configured to synthesize, according to the corresponding relationship, the user audio/video information and the situational audio/video information after the fitting processing to form an audio/video file. There are certain requirements for the length of the entire synthesized audio/video file based on the requirements of the teaching or the requirements for the summary or the requirements for the length of a coursework. In this process, the time or data volume of in the playing of the situational audio/video data should be adjusted according to the actual situation to meet the time requirements, for example, the speed of playing images is improved or reduced. Such adjustment is relatively common in the prior art and will not be described herein. Preferably, the synthesized audio/video file is played by the scenario creating apparatus 20. Preferably, the above synthesized audio/video file is submitted to a teacher as a coursework of situational teaching.

Preferred embodiments of the present invention introduced above are intended to make the spirit of the present invention more apparent and easier to understand, but not to limit the present invention. Any updates, replacements and improvements made within the spirit and principles of the present invention should be regarded as within the scope of protection of the claims of the present invention.

### INDUSTRIAL APPLICABILITY

By using the system of the present invention, the experience and interest of a K12 stage user participating in interactive situational teaching is further enhanced, which is also applicable in solving the problem of coursework submission for interactive situational teaching.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is the claimed is:

1. An interactive situational teaching system for use in K12 stage, comprising a computer apparatus and a scenario creating apparatus, an image acquiring apparatus and a user terminal connected to the computer apparatus, wherein
the image acquiring apparatus comprises a camera for remotely acquiring situational audio/video information of situational teaching;
the scenario creating apparatus comprises a projection device and a sound device, and is configured to project a predetermined scenario stored in the computer apparatus or an actual scenario obtained by the image acquiring apparatus to a target area to display a situational teaching scenario;
the user terminal comprises a recording apparatus and a videoing apparatus, and is configured to acquire user audio/video information and send an operation instruction from a user to the computer apparatus; and
the computer apparatus is configured to receive the operation instruction from the user terminal, control the scenario creating apparatus and the image acquiring apparatus, and synthesize and save the situational audio/video information obtained from the image acquiring apparatus and the user audio/video information obtained from the user terminal as an audio/video file.

2. The system according to claim 1, wherein the computer apparatus comprises a situational audio/video extracting unit, a user audio/video acquiring unit, and an information synthesizing and saving unit, wherein
the situational audio/video extracting unit is configured to extract, according to the preset information set based on a teaching goal, a segment of the situational audio/video information acquired from the image acquiring apparatus that is related to the preset information, such as a video segment, an audio segment or a screenshot image, and establish an association relationship between the preset information and a segment in an order;
the user audio/video acquiring unit is configured to segment, according to the preset information set based on the teaching goal, the user audio/video information acquired by the user terminal, and establish an association relationship between the preset information and a segment; and
the information synthesizing and saving unit is configured to synthesize, according to the preset information, the situational audio/video information and the user audio/video information respectively processed by the situational audio/video extracting unit and the user audio/video acquiring unit into an audio/video file, and save the audio/video file to the computer apparatus.

3. The system according to claim 2, wherein the situational audio/video extracting unit further comprises an information presetting unit, an information comparing unit, a data extracting unit, and a data saving unit, wherein
the information presetting unit is configured to take key points as preset information according to the teaching goal, particularly outline text information of the teaching goal, and set an audio and/or image corresponding to the preset information as reference information;
the information comparing unit is configured to compare the situational audio/video information with the audio and/or image of the reference information, to acquire a time node of the situational audio/video information corresponding to the preset information;
the data extracting unit is configured to extract situational audio/video information corresponding to the preset information based on the time node according to a preset rule of, for example, extracting an image at a fixed time interval, extracting a video segment or an audio segment at a fixed time interval, etc.; and
the data saving unit is configured to save the extracted situational audio/video information in an order, and establish a corresponding association relationship with the preset information.

4. The system according to claim 3, wherein the user audio/video acquiring unit further comprises an audio recognizing unit, a text comparing unit, and a segment marking unit, wherein
the audio recognizing unit is configured to recognize and convert an audio in the obtained user audio/video information into a text content according to a speech recognition model, and establish a corresponding association relationship between the text content and the user audio/video information according to time information, such as digital time stamp information;
the text comparing unit is configured to perform search comparison on the text content according to the preset information, and establish a corresponding association relationship for the text content according to the preset information;
the segment marking unit is configured to establish, according to the corresponding association relationships respectively obtained by the audio recognizing unit and the text comparing unit, a corresponding association relationship between the preset information and the user audio/video information based on the text content, and perform segment marking on the user audio/video information according to the key points of the preset information.

5. The system according to claim 4, wherein the information synthesizing and saving unit further comprises a corresponding relationship processing unit, a data compression processing unit, a time fitting processing unit, and a data synthesis processing unit, wherein the corresponding relationship processing unit is configured to associate, according to the corresponding association relationship with the preset information, the user audio/video information subjected to the segment marking with the situational audio/video information segment extracted by the situational audio/video extracting unit, and establish a corresponding relationship between the user audio/video information and the situational audio/video information;
the data compression processing unit is configured to perform compression processing on the corresponding situational audio/video information according to a preset rule based on the duration of a user audio/video information segment to meet the time requirement of the preset rule;
the time fitting processing unit is configured to perform fitting processing on the user audio/video information based on the segment marking according to the compressed situational audio/video information, for example, add an idle time between segments to complete the play of the situational audio/video information; and
the data synthesis processing unit is configured to synthesize, according to the corresponding relationship, the user audio/video information and the situational audio/video information after the fitting processing to form an audio/video file.

6. The system according to claim 5, wherein the synthesized audio/video file is played by the scenario creating apparatus.

7. The system according to claim 6, wherein the synthesized audio/video file is submitted to a teacher as a coursework of situational teaching.

8. The system according to claim 7, wherein the recording apparatus and the videoing apparatus of the user terminal are apparatuses built in or provided external to the user terminal.

9. The system according to claim 8, wherein the user terminal is a desktop computer, a notebook computer, a smart phone, or a PAD.

10. The system according to claim 9, wherein the user audio/video information is a recorded summative explanation in the order of the key points of the teaching goal according to the requirements of the teaching goal after the user completes the learning or practice of the situational teaching.
